(19) United States
(12) Patent Application Publication
(10) Pub. No.: US 2021/0319285 A1
(43) Pub. Date: Oct. 14, 2021

(54) INFORMATION PROCESSING APPARATUS, INFORMATION PROCESSING METHOD AND COMPUTER READABLE MEDIUM

(71) Applicant: MITSUBISHI ELECTRIC CORPORATION, Tokyo (JP)

(72) Inventor: Naoya OKADA, Tokyo (JP)

(73) Assignee: MITSUBISHI ELECTRIC CORPORATION, Tokyo (JP)

(21) Appl. No.: 17/356,712

(22) Filed: Jun. 24, 2021

Related U.S. Application Data
(63) Continuation of application No. PCT/JP2019/005697, filed on Feb. 15, 2019.

(51) Int. Cl. G06N 3/04

(52) U.S. Cl. CPC G06N 3/04

(57) ABSTRACT

A processing performance computation unit (101) computes processing performance of an embedded device when a neural network having a plurality of layers is implemented. A requirement achievement determination unit (102) determines whether or not the processing performance of the embedded device when the neural network is implemented satisfies required processing performance. A reduction layer specifying unit (103) specifies a reduction layer which is a layer whose calculation amount is to be reduced, from among the plurality of layers, based on a calculation amount of each layer of the neural network, where it is determined by the requirement achievement determination unit (102) that the processing performance of the embedded device when the neural network is implemented does not satisfy the required processing performance.

### CROSS REFERENCE TO RELATED APPLICATIONS

This application is a Continuation of PCT International Application No. PCT/JP2019/005697 filed on Feb. 15, 2019, which is hereby expressly incorporated by reference into the present application.

### TECHNICAL FIELD

The present invention relates to a neural network.

### BACKGROUND ART

A neural network (hereinafter, also simply referred to as a network) requires a large scale of calculation. For this reason, when the neural network without modification is implemented on a device whose resources are limited such as an embedded device, the neural network cannot be operated in real time. In order to operate the neural network in real time on the device whose resources are limited, volume decreasing of the neural network is necessary.

Patent Literature 1 discloses a configuration of improving inference process speed of the neural network.

Patent Literature 1 discloses a configuration of reducing a multiply-accumulate calculation amount in the inference process by reducing a dimensional quantity of a weight matrix. More specifically, Patent Literature 1 discloses a configuration of having less reduction amount as a phase in the neural network becomes earlier and more reduction amount as the phase becomes later in order to minimize deterioration in recognition accuracy due to reduction in calculation amount.

### CITATION LIST

### Patent Literature

Patent Literature 1: JP2018-109947A

### SUMMARY OF INVENTION

### Technical Problem

In the technique of Patent Literature 1, the calculation amount in the later phase of the neural network is reduced more. For this reason, in a neural network whose calculation amount in the later phase is smaller than that in the earlier phase, there is a possibility that the calculation amount in the later phase is reduced more than necessary.

The reduction in the calculation amount affects the recognition accuracy. For this reason, if the calculation amount in the later phase is reduced more than necessary, a situation may arise where a recognition rate deteriorates and required recognition accuracy is not achieved.

As described above, the technique of Patent Literature 1 has a problem that effective reduction in the calculation amount according to distribution of the calculation amount cannot be performed because the distribution of the calculation amount in the neural network is not considered.

One of the main aims of the present invention is to solve such a problem described above. More specifically, the present invention mainly aims to effectively reduce a calculation amount of a neural network according to distribution of the calculation amount in the neural network.

### Solution to Problem

An information processing apparatus according to the present invention includes:

a processing performance computation unit to compute processing performance of a device when a neural network having a plurality of layers is implemented;

a requirement achievement determination unit to determine whether or not the processing performance of the device when the neural network is implemented satisfies required processing performance; and

a reduction layer specifying unit to specify a reduction layer which is a layer whose calculation amount is to be reduced, from among the plurality of layers, based on a calculation amount of each layer of the neural network, where it is determined by the requirement achievement determination unit that the processing performance of the device when the neural network is implemented does not satisfy the required processing performance.

### Advantageous Effects of Invention

According to the present invention, since a reduction layer is specified based on a calculation amount of each layer, it is possible to perform effective reduction in the calculation amount according to distribution of the calculation amount in a neural network.

### BRIEF DESCRIPTION OF DRAWINGS

FIG. 1 is a diagram illustrating examples of a neural network and an embedded device according to a first embodiment;

FIG. 2 is a diagram illustrating examples of a calculation amount and a processing time of each layer according to the first embodiment;

FIG. 3 is a diagram illustrating an example of reduction in a calculation amount according to a conventional technique;

FIG. 4 is a diagram illustrating a bottleneck according to the first embodiment;

FIG. 5 is a diagram illustrating an example of reduction in a calculation amount according to the first embodiment;

FIG. 6 is a flowchart diagram illustrating an outline of operation according to the first embodiment;

FIG. 7 is a diagram illustrating a functional configuration example of an information processing apparatus according to the first embodiment;

FIG. 8 is a diagram illustrating a hardware configuration example of the information processing apparatus according to the first embodiment;

FIG. 9 is a flowchart illustrating an operation example of the information processing apparatus according to the first embodiment;

FIG. 10 is a flowchart illustrating an operation example of the information processing apparatus according to the first embodiment;

FIG. 11 is a diagram illustrating an example of eased reduction in the calculation amount according to the first embodiment;

FIG. 12 is a diagram illustrating an example of additional reduction in the calculation amount according to the first embodiment;

FIG. 13 is a diagram illustrating an example of reduction in a case of a plurality of layers with the same calculation amount, according to the first embodiment; and

FIG. 14 is a diagram illustrating an example of reduction in a case where a difference between calculation amounts of layer with the largest calculation amount and a layer with the second largest calculation amount is smaller than a threshold, according to the first embodiment.

### DESCRIPTION OF EMBODIMENTS

Hereinafter, embodiments of the present invention will be described with reference to the drawings. In the following description of the embodiments and the drawings, the same reference numerals indicate the same or corresponding parts.

### First Embodiment

*** Outline ***

In the present embodiment, volume decreasing of a neural network when the neural network is implemented on a device whose resources are limited such as an embedded device will be described.

More specifically, in the present embodiment, a layer with the largest calculation amount is extracted from among a plurality of layers of the neural network. Then, a calculation amount of the extracted layer is reduced in such a manner that required processing performance is satisfied. Further, after reduction in the calculation amount, by performing re-learning, deterioration in a recognition rate is suppressed.

By repeatedly executing the above procedures, according to the present embodiment, it is possible to obtain a neural network with small calculation amount, which can be implemented on the device whose resources are limited.

*** Procedure ***

Hereinafter, a procedure of volume decreasing of a neural network according to the present embodiment will be described with reference to the drawings.

In the following description and the drawings, parts having the same reference numeral indicate the same or corresponding parts.

In the present embodiment, an example of implementing the neural network on an embedded device such as a CPU (Central Processing Unit) will be described. Further, the embedded device is assumed to sequentially execute processes of the neural network for each layer. Further, a time to be taken for the processes of the neural network can be computed by the following equation.

Σ(processing time for one layer)

Further, the processing time for one layer can be computed by the following equation.

Total number of multiply-accumulate calculations per layer (OP)/processing ability of device (OP/sec)

Note that, the “total number of multiply-accumulate calculations per layer (OP)” can be computed from network specifications (parameters).

The “processing ability of device (OP/sec)” is uniquely decided for each embedded device.

From the above, it is possible to compute the processing performance when the neural network is implemented on the embedded device.

Note that, in the following, the processing performance means “Σ(processing time for one layer)”, that is, a time required for the embedded device to process in all layers of the neural network (total processing time).

In a case of “Σ(processing time for one layer)<required processing performance”, the required processing performance can be achieved even if the current neural network is implemented on the embedded device.

On the other hand, in a case of “Σ(processing time for one layer)>required processing performance”, the required processing performance cannot be achieved if the current neural network is implemented on the embedded device.

In the case of “Σ(processing time for one layer)>required processing performance”, it is necessary to reduce the total number of multiply-accumulate calculations by modifying the neural network.

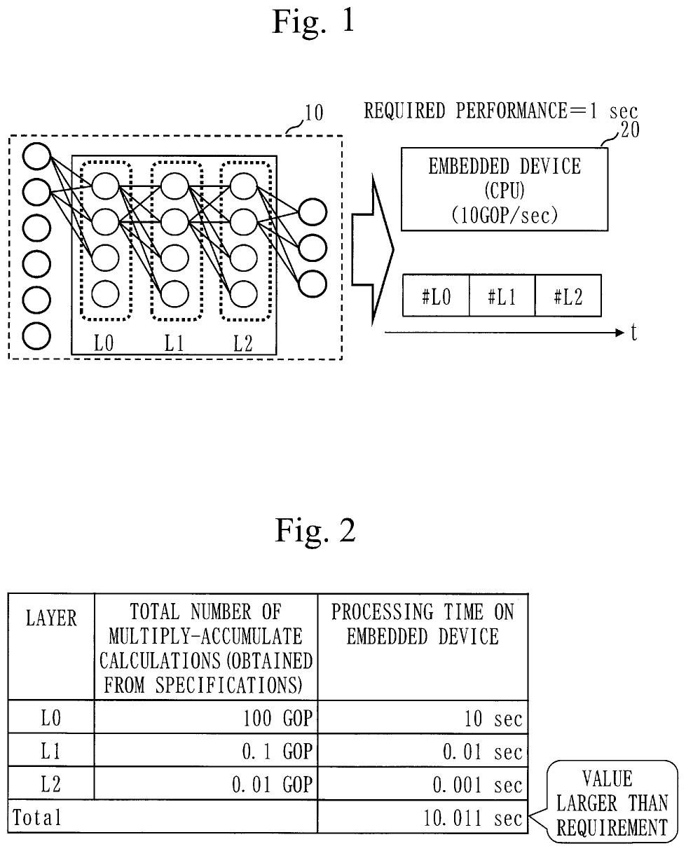

Here, a neural network 10 and an embedded device 20 which are illustrated in FIG. 1 are assumed.

The neural network 10 has an L0 layer, an L1 layer, and an L2 layer. Then, the embedded device 20 processes each layer in an order of the L0 layer, the L1 layer, and the L2 layer. Further, the embedded device 20 has a processing ability of 10 GOP (Giga Operations)/sec.

Further, it is assumed that the required processing performance of the embedded device 20 is one second.

As illustrated in FIG. 2, a calculation amount (total number of multiply-accumulate calculations) of the L0 layer is 100 GOP. A calculation amount (total number of multiply-accumulate calculations) of the L1 layer is 0.1 GOP. A calculation amount (total number of multiply-accumulate calculations) of the L2 layer is 0.01 GOP.

When it is assumed that the neural network 10 without modification is implemented on the embedded device 20, 10 seconds are required for a process of the L0 layer as illustrated in FIG. 2. 0.01 seconds are required for a process of the L1 layer. 0.001 seconds are required for a process of the L2 layer.

A total processing time of the L0 layer, the L1 layer, and the L2 layer is 10.011 seconds, and the required performance is not satisfied. For this reason, it is necessary to reduce the calculation amount (total number of multiply-accumulate calculations) of the neural network 10.

In the technique of Patent Literature 1, the calculation amount is reduced by “having less reduction amount as a phase in a neural network becomes earlier and more reduction amount as the phase becomes later”. For example, if the total number of multiply-accumulate calculations is reduced as follows, it is possible to satisfy the required processing performance.

The reduction amount in the total number of multiply-accumulate calculations of the L0 layer: 91%

The reduction amount in the total number of multiply-accumulate calculations of the L1 layer: 92%

The reduction amount in the total number of multiply-accumulate calculations of the L2 layer: 93%

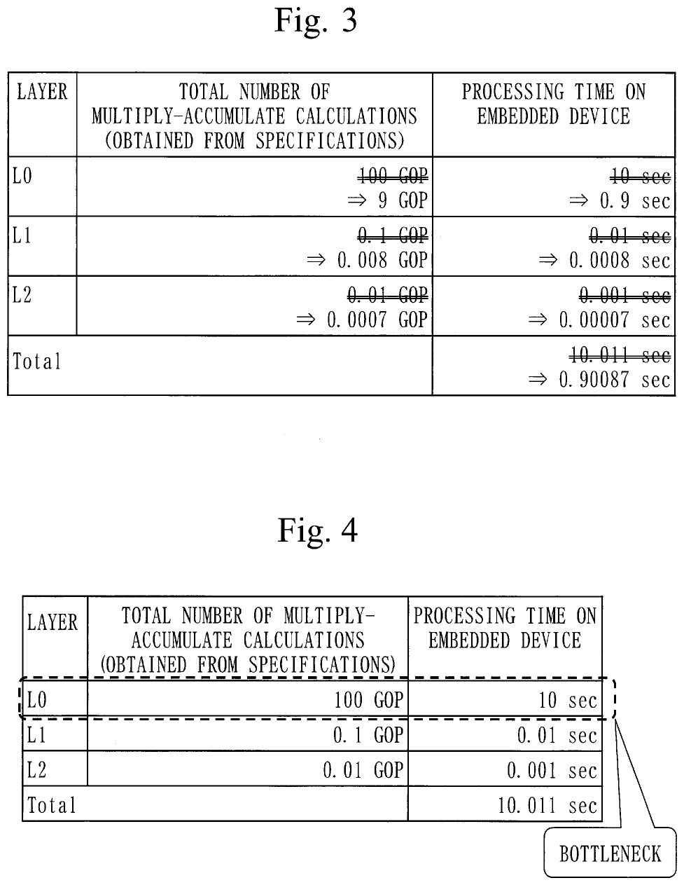

If the above reduction amounts are realized, as illustrated in FIG. 3, the total number of multiply-accumulate calculations of the L0 layer is 9 GOP, the total number of multiply-accumulate calculations of the L1 layer is 0.008 GOP, and the total number of multiply-accumulate calculations of the L2 layer is 0.0007 GOP. As a result, a total of the processing time is 0.90087 seconds, and the required processing performance can be satisfied.

However, since the L2 layer with originally small total number of multiply-accumulate calculations is reduced a lot, deterioration in the recognition rate may arise.

As illustrated in FIG. 4, in the present example, since the L0 layer is a bottleneck, the required processing performance cannot be satisfied.

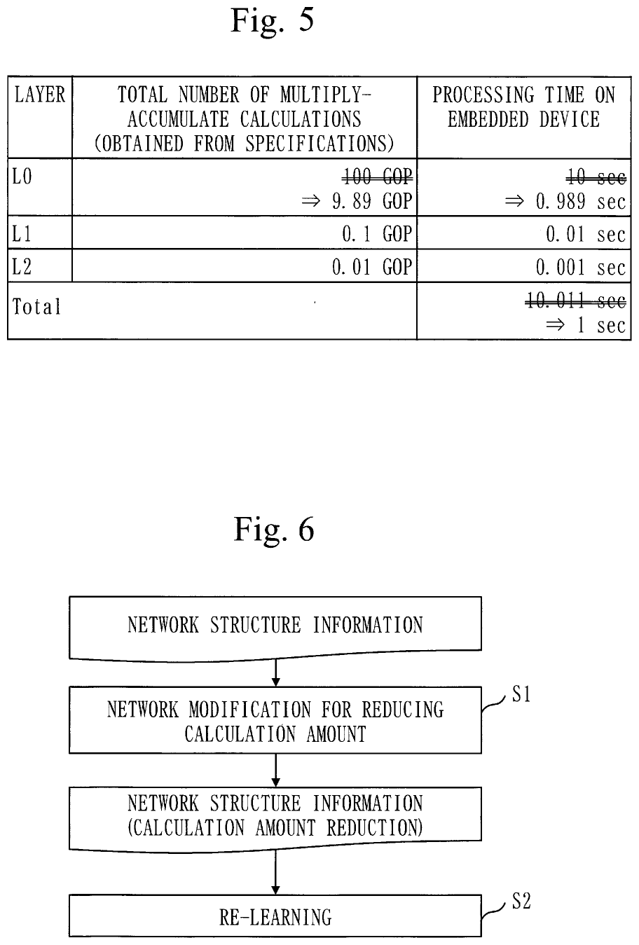

For this reason, in the present embodiment, as illustrated in FIG. 5, the calculation amount of the L0 layer with the largest total number of multiply-accumulate calculations is reduced.

In the following, a layer which is subject to the reduction in the calculation amount is also referred to as a reduction layer.

In the present embodiment, a value of the total number of multiply-accumulate calculations of the reduction layer is computed in such a manner that the required processing performance (1 second in the present example) is satisfied.

In an example of FIG. 5, the processing time of the L0 layer needs to be 0.989 seconds. For this reason, it is necessary to reduce the total number of multiply-accumulate calculations of the L0 layer to 9.89 GOP.

When the reduction layer and the reduction amount (90.11 GOP in the example of FIG. 5) are decided in the above manner, the neural network 10 is modified in such a manner that the total number of multiply-accumulate calculations of the reduction layer is reduced by the reduction amount as illustrated in step S1 of FIG. 6.

Note that, the total number of multiply-accumulate calculations can be reduced by an arbitrary method. For example, the total number of multiply-accumulate calculations may be reduced by pruning.

Further, since the reduction in the calculation amount also affects the recognition accuracy, in the present embodiment, as illustrated in step S2 of FIG. 6, re-learning is performed after the neural network 10 is modified (the reduction in the calculation amount).

If it is found that a desired recognition rate can be achieved as a result of the re-learning, even the neural network 10 after the modification can satisfy the required processing performance and required recognition accuracy on the embedded device 20.

*** Description of Configuration ***

Next, a configuration of an information processing apparatus 100 according to the present embodiment will be described. Note that, operation performed by the information processing apparatus 100 is equivalent to an information processing method and an information processing program.

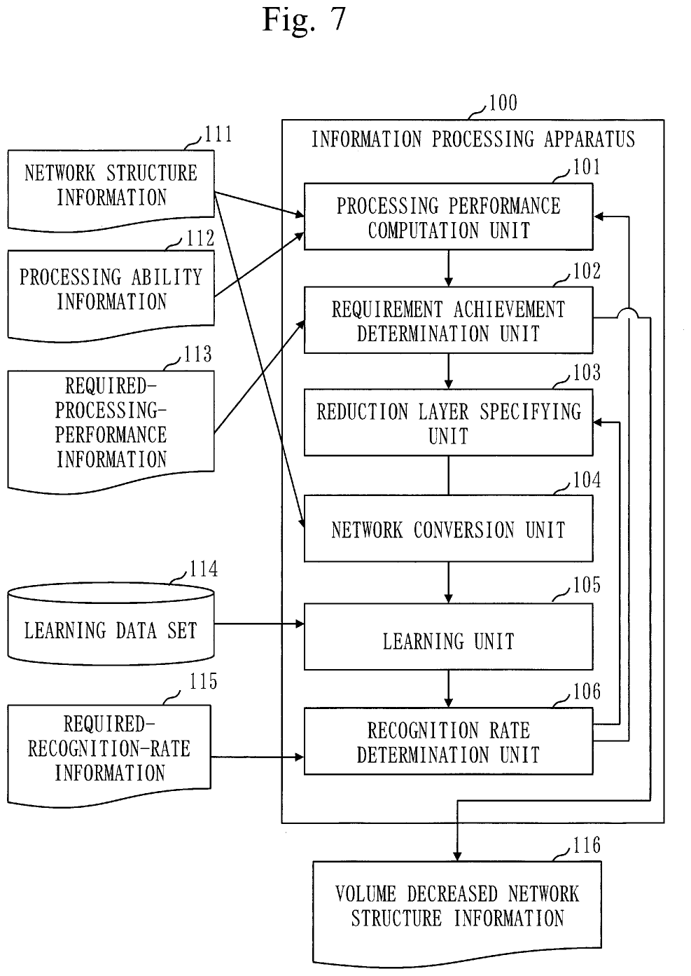

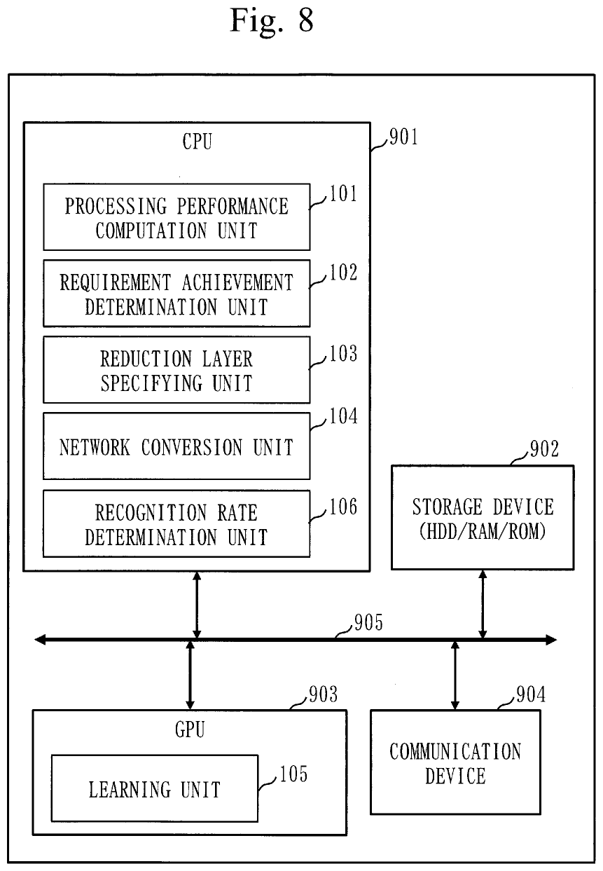

FIG. 7 illustrates a functional configuration example of the information processing apparatus 100, and FIG. 8 illustrates a hardware configuration example of the information processing apparatus 100.

First, the hardware configuration example of the information processing apparatus 100 will be described with reference to FIG. 8.

*** Description of Configuration ***

The information processing apparatus 100 according to the present embodiment is a computer.

The information processing apparatus 100 includes a CPU 901, a storage device 902, a GPU (Graphics Processing Unit) 903, a communication device 904, and a bus 905 as pieces of hardware.

The CPU 901, the storage device 902, the GPU 903, and the communication device 904 are connected to the bus 905.

The CPU 901 and the GPU 903 are ICs (Integrated Circuits) that perform processing.

The CPU 901 executes a program that realizes functions of a processing performance computation unit 101, a requirement achievement determination unit 102, a reduction layer specifying unit 103, a network conversion unit 104, and a recognition rate determination unit 106 which will be described later.

The GPU 903 executes a program that realizes a function of a learning unit 105 which will be described later.

The storage device 902 is an HDD (Hard Disk Drive), a RAM (Random Access Memory), a ROM (Read Only Memory), or the like.

The storage device 902 stores the program that realizes the functions of the processing performance computation unit 101, the requirement achievement determination unit 102, the reduction layer specifying unit 103, the network conversion unit 104, the learning unit 105, and the recognition rate determination unit 106. As described above, the program that realizes the functions of the processing performance computation unit 101, the requirement achievement determination unit 102, the reduction layer specifying unit 103, the network conversion unit 104, and the recognition rate determination unit 106 is read into the CPU 901 and executed by the CPU 901. The program that realizes the function of the learning unit 105 is read into the GPU 903 and executed by the GPU 903.

In FIG. 8, a state where the CPU 901 executes the program that realizes the functions of the processing performance computation unit 101, the requirement achievement determination unit 102, the reduction layer specifying unit 103, the network conversion unit 104, and the recognition rate determination unit 106 is schematically illustrated. Further, FIG. 8 schematically illustrates a state where the GPU 903 executes the program that realizes the function of the learning unit 105.

The communication device 904 is an electronic circuit that executes a communication process of data.

The communication device 904 is, for example, a communication chip or an NIC (Network Interface Card).

Next, the functional configuration example of the information processing apparatus 100 will be described with reference to FIG. 7.

The processing performance computation unit 101 computes the processing performance of the embedded device 20 when the neural network 10 is implemented on the embedded device 20, by using network structure information 111 and processing ability information 112.

The network structure information 111 indicates the total number of multiply-accumulate calculations for each layer of the neural network 10 exemplified in FIG. 2. In the network structure information 111, specifications of the neural network 10 from which the total number of multiply-accumulate calculations of each layer can be computed may be described instead of the total number of multiply-accumulate calculations of each layer.

The processing ability information 112 indicates the processing ability (10 GOP/sec) of the embedded device 20 exemplified in FIG. 2. In the processing ability information 112, specifications of the embedded device 20 from which the processing ability of the embedded device 20 can be computed may be described instead of the processing ability of the embedded device 20.

Note that, a process performed by the processing performance computation unit 101 is equivalent to a processing performance computation process.

The requirement achievement determination unit 102 determines whether or not the processing performance of the embedded device 20 computed by the processing performance computation unit 101 satisfies the required processing performance described in required-processing-performance information 113.

A process performed by the requirement achievement determination unit 102 is equivalent to a requirement achievement determination process.

The reduction layer specifying unit 103 specifies the reduction layer and the reduction amount in the calculation amount of the reduction layer.

That is, when the requirement achievement determination unit 102 determines that the processing performance of the embedded device 20 when the neural network 10 is implemented does not satisfy the required processing performance, the reduction layer specifying unit 103 specifies a reduction layer that is a layer whose calculation amount is to be reduced, from among a plurality of layers based on the calculation amount of each layer of the neural network 10. More specifically, the reduction layer specifying unit 103 specifies as the reduction layer, a layer with the largest calculation amount. Further, the reduction layer specifying unit 103 decides the reduction amount in the calculation amount of the reduction layer in such a manner that the processing performance of the embedded device 20 when the neural network 10 after reduction in the calculation amount is implemented, satisfies the required processing performance.

A process performed by the reduction layer specifying unit 103 is equivalent to a reduction layer specifying process.

The network conversion unit 104 converts the neural network 10 in such a manner that the calculation amount of the reduction layer specified by the reduction layer specifying unit 103 is reduced by the reduction amount decided by the reduction layer specifying unit 103.

The learning unit 105 learns the neural network 10 after the conversion by the network conversion unit 104, by using a learning data set 114.

The recognition rate determination unit 106 analyzes a learning result of the learning unit 105 and determines whether or not the recognition rate of the neural network 10 after the conversion satisfies the required recognition rate described in required-recognition-rate information 115.

When the recognition rate of the neural network 10 after the conversion satisfies the required recognition rate, and the processing performance of the embedded device 20 when the neural network 10 after the conversion is implemented satisfies the required processing performance, the requirement achievement determination unit 102 outputs volume decreased network structure information 116.

In the volume decreased network structure information 116, the total number of multiply-accumulate calculations of each layer of the neural network 10 after the conversion is indicated.

*** Description of Operation ***

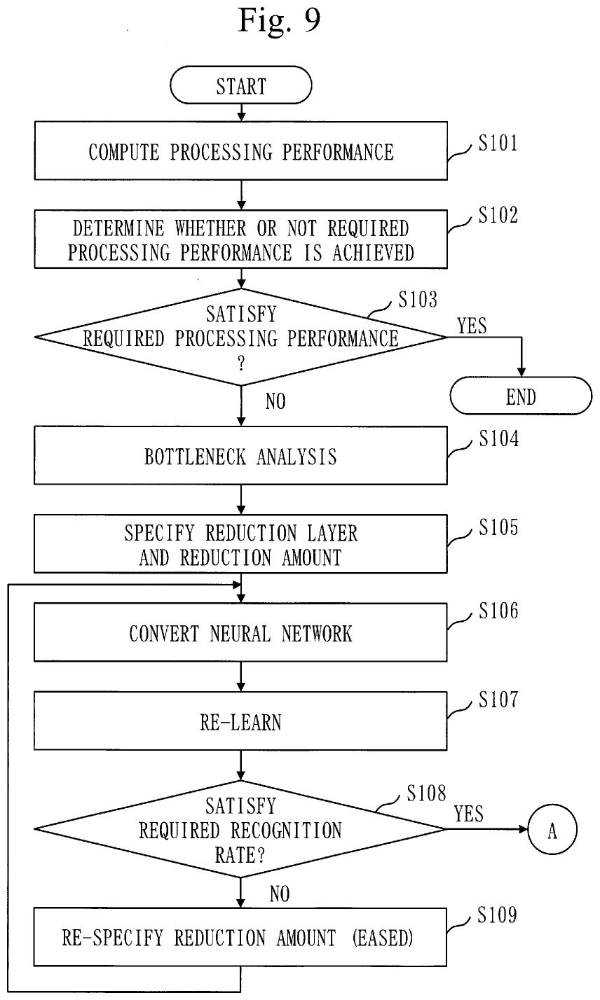

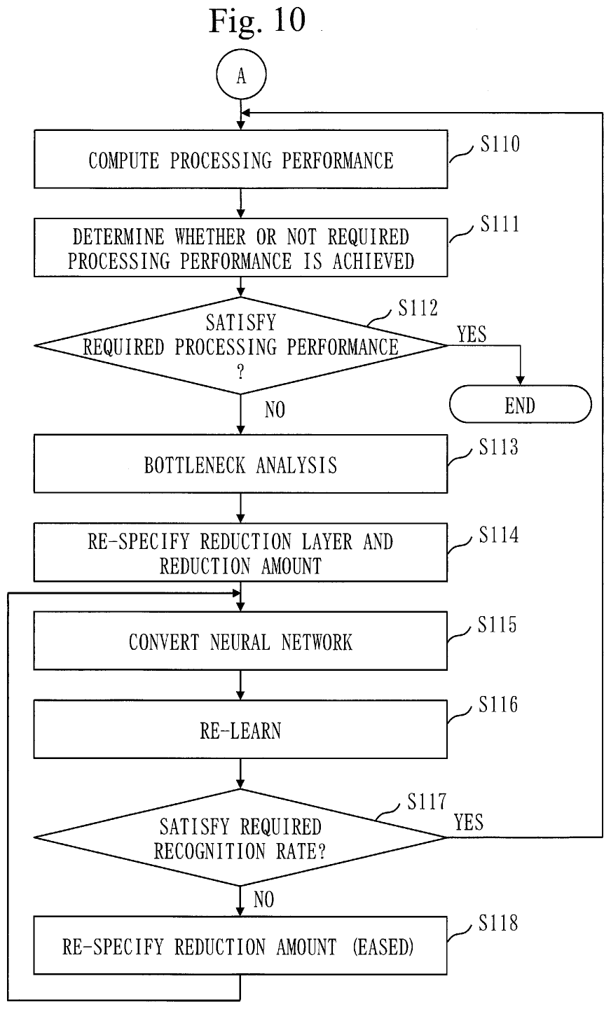

Next, an operation example of the information processing apparatus 100 according to the present embodiment will be described with reference to FIGS. 9 and 10.

First, the processing performance computation unit 101 acquires the network structure information 111 and the processing ability information 112, and computes the processing performance of the embedded device 20 when the neural network 10 is implemented on the embedded device 20, by using the network structure information 111 and the processing ability information 112 which have been acquired (step S101).

The processing performance computation unit 101 computes the processing time of each layer based on “total number of multiply-accumulate calculations per layer (OP)/processing ability of device (OP/sec)”, and obtains the processing performance of the embedded device 20 by totaling up the computed processing time of each layer.

Next, the requirement achievement determination unit 102 determines whether or not the processing performance of the embedded device 20 computed by the processing performance computation unit 101 satisfies the required processing performance described in the required-processing-performance information 113 (step S102).

When the processing performance of the embedded device 20 satisfies the required processing performance (YES in step S103), the process ends.

When the processing performance of the embedded device 20 does not satisfy the required processing performance (NO in step S103), the reduction layer specifying unit 103 performs a bottleneck analysis (step S104) and specifies the reduction layer and the reduction amount in the calculation amount of the reduction layer (step S105).

Specifically, the reduction layer specifying unit 103 acquires from the requirement achievement determination unit 102, information in which the total number of multiply-accumulate calculations and the processing time of each layer exemplified in FIG. 4 are described. Further, the reduction layer specifying unit 103 specifies as the reduction layer, a layer with the largest total number of multiply-accumulate calculations.

Further, the reduction layer specifying unit 103 outputs to the network conversion unit 104, information notifying of the reduction layer and the reduction amount.

Next, the network conversion unit 104 converts the neural network 10 in such a manner that the total number of multiply-accumulate calculations of the reduction layer specified by the reduction layer specifying unit 103 is reduced by the reduction amount decided by the reduction layer specifying unit 103 (step S106).

The network conversion unit 104 converts the neural network with reference to the network structure information 111.

Further, the network conversion unit 104 notifies the learning unit 105 of the neural network 10 after the conversion.

Next, the learning unit 105 learns the neural network 10 after the conversion by the network conversion unit 104, by using the learning data set 114 (step S107).

The learning unit 105 outputs a learning result to the recognition rate determination unit 106.

Next, the recognition rate determination unit 106 analyzes the learning result of the learning unit 105 and determines whether or not the recognition rate of the neural network 10 after the conversion satisfies the required recognition rate described in the required-recognition-rate information 115 (step S108).

When the recognition rate of the neural network 10 after the conversion does not satisfy the required recognition rate, the recognition rate determination unit 106 notifies the reduction layer specifying unit 103 that the recognition rate does not satisfy the required recognition rate.

On the other hand, when the recognition rate of the neural network 10 after the conversion satisfies the required recognition rate, the recognition rate determination unit 106 notifies the processing performance computation unit 101 that the recognition rate satisfies the required recognition rate.

When the recognition rate of the neural network 10 after the conversion does not satisfy the required recognition rate (NO in step S108), the reduction layer specifying unit 103 performs re-specifying of the reduction amount (step S109). In the re-specifying of the reduction amount, the reduction layer specifying unit 103 eases the reduction amount.

That is, the reduction layer specifying unit 103 decides eased reduction amount if the recognition rate when the neural network 10 after reduction in the calculation amount is implemented on the embedded device 20 does not satisfy the required recognition rate.

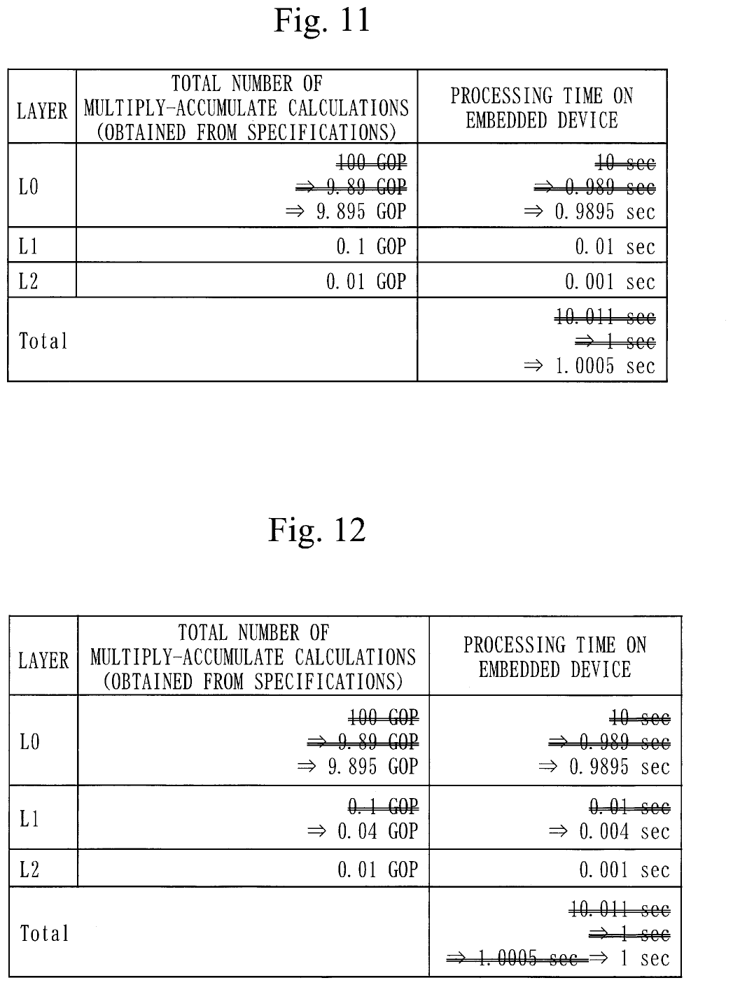

For example, the reduction layer specifying unit 103 eases the reduction amount as illustrated in FIG. 11.

In FIG. 11, the reduction layer specifying unit 103 eases the reduction amount by increasing the total number of multiply-accumulate calculations of the L0 layer from 9.89 GOP to 9.895 GOP. In this case, the processing performance is 1.0005 seconds, and the required processing performance is barely unsatisfied.

When the recognition rate of the neural network 10 after the conversion satisfies the required recognition rate (YES in step S108), the processing performance computation unit 101 computes the processing performance of the embedded device 20 for the neural network 10 after the conversion (step S110).

That is, the processing performance computation unit 101 computes the processing performance of the embedded device 20 by using the network structure information 111 and the processing ability information 112 on the neural network 10 after the conversion.

Next, the requirement achievement determination unit 102 determines whether or not the processing performance of the embedded device 20 computed by the processing performance computation unit 101 satisfies the required processing performance described in the required-processing-performance information 113 (step S111).

When the processing performance of the embedded device 20 satisfies the required processing performance (YES in step S112), the process ends. At this time, the requirement achievement determination unit 102 outputs the volume decreased network structure information 116 to a predetermined output destination.

When the processing performance of the embedded device 20 does not satisfy the required processing performance (NO in step S112), the reduction layer specifying unit 103 performs a bottleneck analysis (step S113) and re-specifies the reduction layer and the reduction amount in the calculation amount of the reduction layer (step S114).

In step S114, the reduction layer specifying unit 103 specifies as an additional reduction layer, a layer that has not been specified as the reduction layer yet.

For example, the reduction layer specifying unit 103 specifies as the additional reduction layer, a layer with the largest total number of multiply-accumulate calculations, among the layers that have not yet been specified as the reduction layer.

In an example of FIG. 12, since the L0 layer has already been specified as the reduction layer and the total number of multiply-accumulate calculations of the L1 layer is larger than the total number of multiply-accumulate calculations of the L2, the reduction layer specifying unit 103 specifies the L1 layer as the additional reduction layer. Then, in the example of FIG. 12, the reduction layer specifying unit 103 decides that the total number of multiply-accumulate calculations of the L1 layer is reduced to 0.04 GOP (reduction amount: 0.06 GOP). As a result, the processing performance is 1 second, and the required processing performance is satisfied.

Note that, when all the layers have already been specified as the reduction layer, the reduction layer specifying unit 103 specifies as the additional reduction layer, a layer with the largest calculation amount after the reduction.

Since steps S115 to S118 are the same as steps S106 to S109, descriptions will be omitted.

In the above, an example is used in which the total number of multiply-accumulate calculations of the L0 layer is larger than those of the L1 layer and the L2 layer.

However, depending on the neural network, there may be a plurality of layers with the same total number of multiply-accumulate calculations. In such a case, the reduction layer specifying unit 103 prioritizes and specifies a layer in a later phase as the reduction layer. That is, when there are two or more layers with the largest total number of multiply-accumulate calculations, the reduction layer specifying unit 103 specifies as the reduction layer, a layer in a last phase among the two or more layers with the largest total number of multiply-accumulate calculations. This is because the later phase the layer is in, the less likely deterioration in the recognition rate due to the reduction in the calculation amount arises.

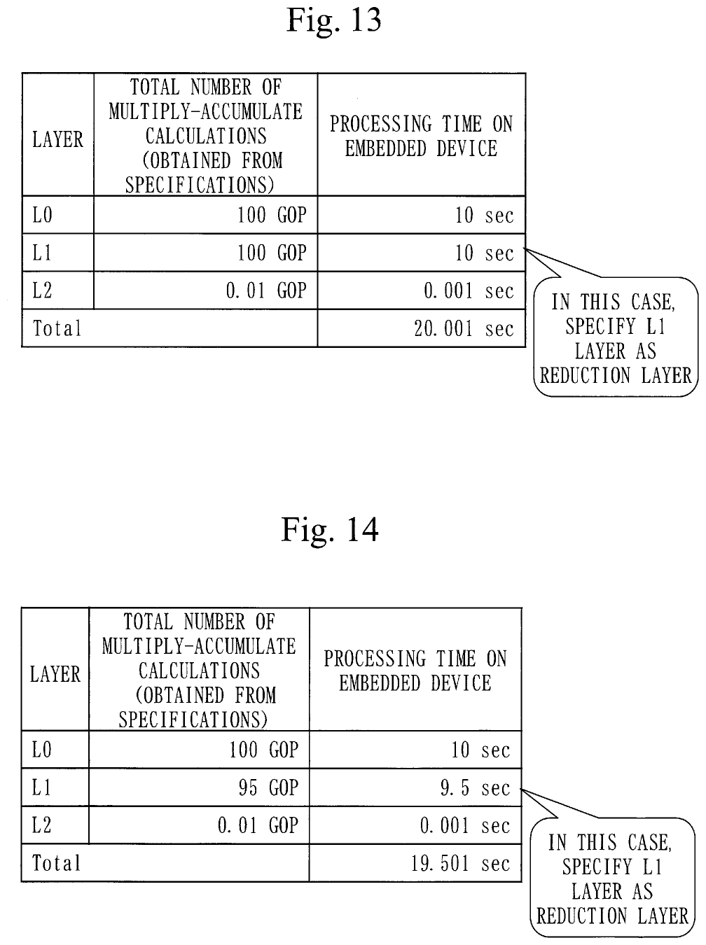

For example, as illustrated in FIG. 13, when the total number of multiply-accumulate calculations of the L0 layer and the total number of multiply-accumulate calculations of the L1 layer are both 100 GOP, the reduction layer specifying unit 103 specifies as the reduction layer, the L1 layer which is the layer in the later phase.

Further, when a difference between the calculation amount of the layer with the largest calculation amount and the calculation amount of a layer with the second largest calculation amount is smaller than a threshold, and when the layer with the second largest calculation amount is located in a later phase than the layer with the largest calculation amount, the reduction layer specifying unit 103 may specify as the reduction layer, the layer with the second largest calculation amount.

For example, it is assumed that the threshold is 10% of the calculation amount of the layer with the largest calculation amount. In this case, as illustrated in FIG. 14, when the total number of multiply-accumulate calculations of the L0 layer is 100 GOP and the total number of multiply-accumulate calculations of the L1 layer is 95 GOP, a difference between the total numbers of multiply-accumulate calculations of the L0 layer and the L1 layer is smaller than 10% of the total number of multiply-accumulate calculations of the L0 layer. Therefore, the reduction layer specifying unit 103 specifies as the reduction layer, the L1 layer which is the layer in the later phase.

Note that, the threshold is not limited to 10%. A user of the information processing apparatus 100 can arbitrarily set the threshold.

*** Description of Effect of Embodiment ***

As described above, according to the present embodiment, since the reduction layer is specified based on the calculation amount of each layer, it is possible to effectively reduce the calculation amount according to the distribution of the calculation amount in the neural network.

Further, according to the present embodiment, a designer of the neural network can automatically obtain the neural network that satisfies the required processing performance of the embedded device even without knowledge about the embedded device of an implementation target.

Similarly, according to the present embodiment, a person in charge of the implementation on the embedded device can automatically obtain the neural network that satisfies the required processing performance of the embedded device even without knowledge about the neural network.

*** Description of Hardware Configuration ***

Finally, supplementary descriptions of the hardware configuration of the information processing apparatus 100 will be given.

An OS (Operating System) is stored in the storage device 902.

Then, at least a part of the OS is executed by the CPU 901.

The CPU 901 executes a program that realizes functions of the processing performance computation unit 101, the requirement achievement determination unit 102, the reduction layer specifying unit 103, the network conversion unit 104, and the recognition rate determination unit 106 while executing at least the part of the OS.

By the CPU 901 executing the OS, task management, memory management, file management, communication control, and the like are performed.

Further, at least one of information, data, a signal value, and a variable value indicating a processing result of the processing performance computation unit 101, the requirement achievement determination unit 102, the reduction layer specifying unit 103, the network conversion unit 104, the learning unit 105, and the recognition rate determination unit 106 is stored in at least one of the storage device 902, a register, and a cache memory.

Further, the program that realizes the functions of the processing performance computation unit 101, the requirement achievement determination unit 102, the reduction layer specifying unit 103, the network conversion unit 104, the learning unit 105, and the recognition rate determination unit 106 may be stored in a portable recording medium such as a magnetic disk, a flexible disk, an optical disk, a compact disc, a Blu-ray (registered trademark) disk, a DVD, or the like. Then, the portable recording medium storing the program that realizes the functions of the processing performance computation unit 101, the requirement achievement determination unit 102, the reduction layer specifying unit 103, the network conversion unit 104, the learning unit 105, and the recognition rate determination unit 106 may be commercially distributed.

Further, “unit” of the processing performance computation unit 101, the requirement achievement determination unit 102, the reduction layer specifying unit 103, the network conversion unit 104, the learning unit 105, and the recognition rate determination unit 106 may be read as “circuit” or “step” or “procedure” or “process”.

Further, the information processing apparatus 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

10: neural network, 20: embedded device, 100: information processing apparatus, 101: processing performance computation unit, 102: requirement achievement determination unit, 103: reduction layer specifying unit, 104: network conversion unit, 105: learning unit, 106: recognition rate determination unit, 111: network structure information, 112: processing ability information, 113: required-processing-performance information, 114: learning data set, 115: required-recognition-rate information, 116: volume decreased network structure information, 901: CPU, 902: storage device, 903: GPU, 904: communication device, 905: bus.

1. An information processing apparatus comprising:
processing circuitry
to compute processing performance of a device when a neural network having a plurality of layers is implemented;
to determine whether or not the processing performance of the device when the neural network is implemented satisfies required processing performance; and
to specify a reduction layer which is a layer whose calculation amount is to be reduced, from among the plurality of layers, based on a calculation amount of each layer of the neural network, where it is determined that the processing performance of the device when the neural network is implemented does not satisfy the required processing performance.

2. The information processing apparatus according to claim 1,
wherein the processing circuitry specifies a layer with the largest calculation amount as the reduction layer.

3. The information processing apparatus according to claim 2,
wherein where there are two or more layers with the largest calculation amount, the processing circuitry specifies as the reduction layer, a layer in a last phase among the two or more layers with the largest calculation amount.

4. The information processing apparatus according to claim 1,
wherein where a difference between a calculation amount of a layer with the largest calculation amount and a calculation amount of a layer with the second largest calculation amount is smaller than a threshold, and where the layer with the second largest calculation amount is located in a later phase than the layer with the largest calculation amount, the processing circuitry specifies the layer with the second largest calculation amount as the reduction layer.

5. The information processing apparatus according to claim 1,
wherein the processing circuitry decides a reduction amount in the calculation amount of the reduction layer in such a manner that the processing performance of the device when a neural network after reduction in the calculation amount is implemented, satisfies the required processing performance.

6. The information processing apparatus according to claim 1,
wherein where the processing performance of the device when a neural network after reduction in the calculation amount is implemented on the device, does not satisfy the required processing performance, the processing circuitry specifies an additional reduction layer from among the plurality of layers.

7. The information processing apparatus according to claim 6,
wherein the processing circuitry specifies as the additional reduction layer, a layer with the largest calculation amount among layers which have not been specified as the reduction layer yet.

8. The information processing apparatus according to claim 6,
wherein where all of the plurality of layers have been specified as the reduction layer, the processing circuitry specifies as the additional reduction layer, a layer with the largest calculation amount after reduction.

9. The information processing apparatus according to claim 1,
wherein the processing circuitry decides an eased reduction amount, where a recognition rate when a neural network after reduction in the calculation amount is implemented on the device does not satisfy a required recognition rate.

10. An information processing method comprising:
computing processing performance of a device when a neural network having a plurality of layers is implemented;
determining whether or not the processing performance of the device when the neural network is implemented satisfies required processing performance; and
specifying a reduction layer which is a layer whose calculation amount is to be reduced, from among the plurality of layers, based on a calculation amount of each layer of the neural network, where it is determined that the processing performance of the device when the neural network is implemented does not satisfy the required processing performance.

11. A non-transitory computer readable medium storing an information processing program which causes a computer to execute:
a processing performance computation process of computing processing performance of a device when a neural network having a plurality of layers is implemented;
a requirement achievement determination process of determining whether or not the processing performance of the device when the neural network is implemented satisfies required processing performance; and
a reduction layer specifying process of specifying a reduction layer which is a layer whose calculation amount is to be reduced, from among the plurality of layers, based on a calculation amount of each layer of the neural network, where it is determined by the requirement achievement determination process that the processing performance of the device when the neural network is implemented does not satisfy the required processing performance.
